(19) United States
(12) Patent Application Publication
(10) Pub. No.: US 2012/0301972 A1
(43) Pub. Date: Nov. 29, 2012

(54) CENTRIFUGATION APPARATUS, USE THEREOF AND CENTRIFUGATION METHOD

(75) Inventors: Stig Morten Borch, Oslo (NO); Esben Beck, Fjellhamar (NO)

(73) Assignee: STIFTELSEN SINTEF, Oslo (NO)

(21) Appl. No.: 13/519,865

(22) PCT Filed: Dec. 28, 2010
(86) PCT No.: PCT/NO2010/000489

§ 371 Date: Jul. 18, 2012

(30) Foreign Application Priority Data
Dec. 29, 2009 (NO) 20093597

(51) Int. Cl. G01N 1/34

(52) U.S. Cl. 436/177; 422/533

(57) ABSTRACT

The present invention relates to a centrifuge apparatus (10) comprising: a support member (12) rotatable about a first axis (20); at least one holding means (22) mounted to said support member for rotation therewith about the first axis, wherein each holding means is adapted to rotate about a respective second axis (24) distal to said first axis and to receive a sample processing device (26) for rotation thereof also about the second axis; a first motor (28a) adapted to rotate said support member about said first axis; and a second motor (28b) coupled to said at least one holding means; wherein the two motors (28a, 28b) are placed off the support member on opposite sides of the support member. The invention also relates to use of such an apparatus, and to a centrifugation method.

The present invention relates to a centrifuge apparatus, use of such an apparatus, and a centrifugation method.

Centrifugation as a mean for accelerating sedimentation of cells, particles and precipitates as well as for separation of liquids or cells with different density has long been an integral part of chemical and biochemical protocols.

Two-dimensional centrifugation is generally obtained in an apparatus that performs rotation of the individual cartridges around one axis, while these cartridges are being rotated by separate means around other distal axes.

The U.S. Pat. No. 4,814,282 (Holen et al.) discloses a centrifuge apparatus including a circular plate which is mounted on a vertical axis for rotation about the axis. The plate is driven by an electric motor. Mounted on the plate are two sample processor card holders, each adapted to receive a sample processor card. Each card holder is in the nature of a tray and is rotatably mounted relative to the plate on an axis operatively connected to a separate drive means to rotate the card holder.

The European patent application EP 1 302 244 A1 (Agilent Technologies, Inc) discloses an array-hybridization system. The system comprises a centrifuge motor, a centrifuge drive chain, a centrifuge drive shaft, and a centrifuge rotor or “turntable”. The system further comprises an agitation-drive motor, an agitation-drive chain, an agitation-drive shaft, an agitation-drive gear, and three agitation-drive mounts. The agitation-drive mounts are rotatably coupled to the turntable. Each agitation-drive mount holds a reaction cell. The motors, which are both servo motors, are located below the turntable. The agitation drive shaft and centrifuge drive shaft are coaxial, with agitation drive shaft extending though a hollow centrifuge shaft. When there is no agitation, the agitation motor rotates at exactly half the rate of centrifuge motor. To effect agitation, the rotation rate of the agitation motor is increased and decreased in a controlled manner so that it alternately leads and lags the centrifuge motor in phase. The agitation amplitude is selected to be about +/−6 DEG to effect full “sloshing” of a sample liquid.

US 2006/083667 A1 (Kohara et al.) discloses a chemical reaction device and a chemical reaction apparatus supposedly capable of performing transverse liquid movement in a simple structure and at low cost without causing contamination and air bubbles. There is installed a mechanism for supporting the chemical reaction device in any other position than a center of a turntable which can be rotated, for moving liquid by a centrifugal force due to rotation, and for reversing a direction of the flow path independently of the turntable.

WO 2009085884 A1 discloses apparatus, methods, and systems for sample processing utilizing an optical element to open and/or close a valve.

It is an object of the present invention to provide an improved centrifuge apparatus and method.

This object, and other objects that will be apparent from the following description, is achieved by the present invention as defined in the appended independent claim(s). Further embodiments are set forth in the appended dependent claims.

According to an aspect of the present invention, there is provided a centrifuge apparatus, the apparatus comprising: a support member rotatable about a first axis; at least one holding means mounted to said support member for rotation therewith about the first axis, wherein each holding means is adapted to rotate about a respective second axis distal to said first axis and to receive a sample processing device for rotation thereof also about the second axis; a first motor adapted to rotate said support member about said first axis; and a second motor coupled to said at least one holding means; wherein the two motors are placed off the support member on opposite sides of the support member. The first motor may be fixed to the support member via a first drive shaft co-axial with the first axis. Further, the second motor may be coupled to the at least one holding means via a second drive shaft co-axial with the first axis. Further, the apparatus may be arranged such that the at least one holding means does not rotate about the respective second axis when the first and second drive shafts are rotated at the same speed (and in the same direction), but does rotate about the respective second axis when the first and second drive shafts are rotated at different speeds (but in the same direction).

The present centrifuge apparatus allows precise control of centrifugation of a sample contained in the sample processing cartridge. Further, by placing the two motors on opposite sides of the support member, no complicated construction where the drive shaft of one of the motors extends though the (hollow) drive shaft of the other motor is necessary, which provides for a more robust centrifuge apparatus. Also, by placing the motors off the support member, space may be freed on the support member for possible other components. Further, as no motors are placed on the support member, no electric power generator at the support member or any power transfer mechanism to the rotating support member will be necessary. Further, the first and second drive shafts being co-axial with the first axis allows a symmetric and balanced construction of the apparatus.

The second drive shaft may be provided with a gear in direct or indirect engagement with teeth on the holding means. Hence, the transmission between the second motor and the holding means may be geared, to minimize the influence of any minor discrepancy in speed of the two motors. “indirect” engagement means here that at least one intermediate gear may be operatively provided between the second drive shaft and the teeth of the holding means.

The two motors may be servo motors. This allows the speed and the position of both the motors at any time to be accurately defined. Alternatively, accurately defined speed and position of both the motors at any time can be achieved by indirect means typically based on sensor systems at any time measuring speed and position of both motors.

The apparatus may further comprise a light source for at least partly illuminating a sample processing device received by the holding means. The light source may for instance be a strobe light source adapted to emit strobe light.

The apparatus may further comprise an optical sensor or camera placed at a different angular position about said first axis compared to said light source. This allows the optical sensor (or camera) to be placed physically shielded from other components of the apparatus, such as the light source. This embodiment may for instance be used for analysing chemoluminescent reaction products or fluorophores or other samples which emit light some time after being exited by the light source such as time resolved fluorescence.

The apparatus may further comprise at least one reflecting element arranged in the support member or holding means and adapted to redirect incoming light (e.g. from the light source) in a longitudinal direction of the support member, and vice versa. In this way, the light may pass a longer path through the sample processing cartridge and thereby increase the sensitivity and accuracy. Further, an optical sensor or camera may be placed at the rim of the support member, to capture the redirected light.

The apparatus may further comprise at least one of: at least one sensor provided to the support member; at least one sensor provided to the at least one holding means; at least one actuator provided to the support member; and at least one actuator provided to the at least one holding means. The at least one sensor/actuator may for instance be placed on or in the support member/holding means. Further, the at least one sensor/actuator may be magnetic, optical, or thermal.

The sample processing device may be a micro-fluidic sample processing device, and it may be included in the apparatus.

Instead of the two motors being place on opposite sides of the support member, the second motor may instead be placed on the same side of the support member as the first motor.

Another aspect of the present invention relates to the use of the present apparatus for centrifugation, in particular two-dimensional centrifugation of at least one sample in a micro-fluidic sample processing device. In this use, the direction of the centrifugal force acting on the sample(s) in the sample processing device may be altered at will. That is, the amount or sequence of rotation of the holding means about its second axis is by no way limited, but may be set completely optionally or “arbitrarily” depending on the circumstances. Further, the use of the present apparatus relates to the performance of complete analytical protocols integrating both sample preparation and assaying steps within a sealed cartridge (sample processing device). This is obtained by combining smart microfluidic designs of the cartridge applied to two-dimensional centrifugation allowing controlled liquid processing (liquid transfer between cavities, splitting, metering, mixing, dissolving and more), e.g. with the use density separation and trapping of liquids and/or particles of different density as described in the applicant's co-pending patent application entitled “Sample processing cartridge and method of processing and/or analysing a sample under centrifugal force”. Overall, this use is different from the use of the system in EP 1 302 244 A1 at least in that it allows total control over the movements and position of the samples at any given time.

According to yet another aspect of the present invention, there is provided a method for two-dimensional centrifugation, the method comprising: supplying at least one sample and optionally one or more reagents in a micro-fluidic sample processing device; placing the micro-fluidic sample processing device containing the at least one sample in the holding means of an apparatus according to the first described aspect of the invention; operating the two motors at the same speed for subjecting the sample to a centrifugal force acting in a first direction; and changing the speed of one of the motors for subjecting the sample to a centrifugal force acting in a second direction. This aspect may exhibit similar features and technical effects as the previously described aspects.

These aspects and more of the present invention will now be described in further detail, with reference to the appended drawings showing embodiments of the invention.

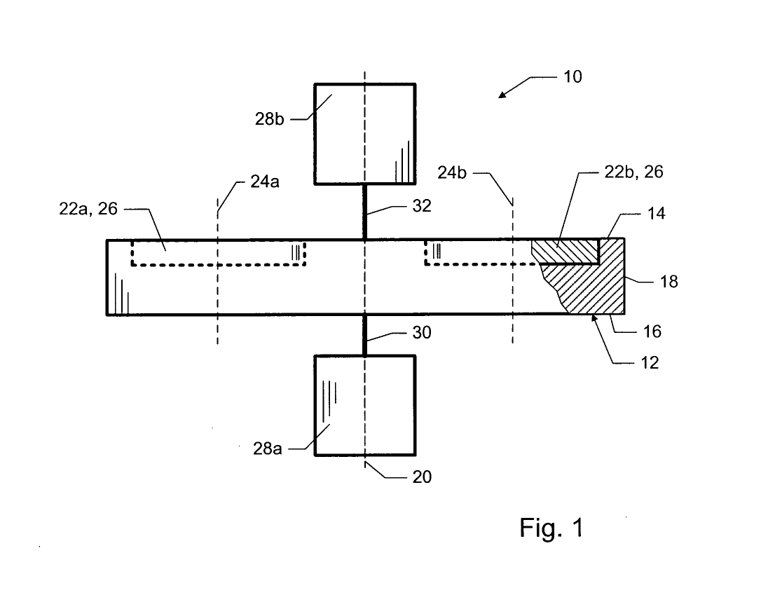

FIG. 1 is a schematic side view of a centrifuge apparatus according an embodiment of the invention.

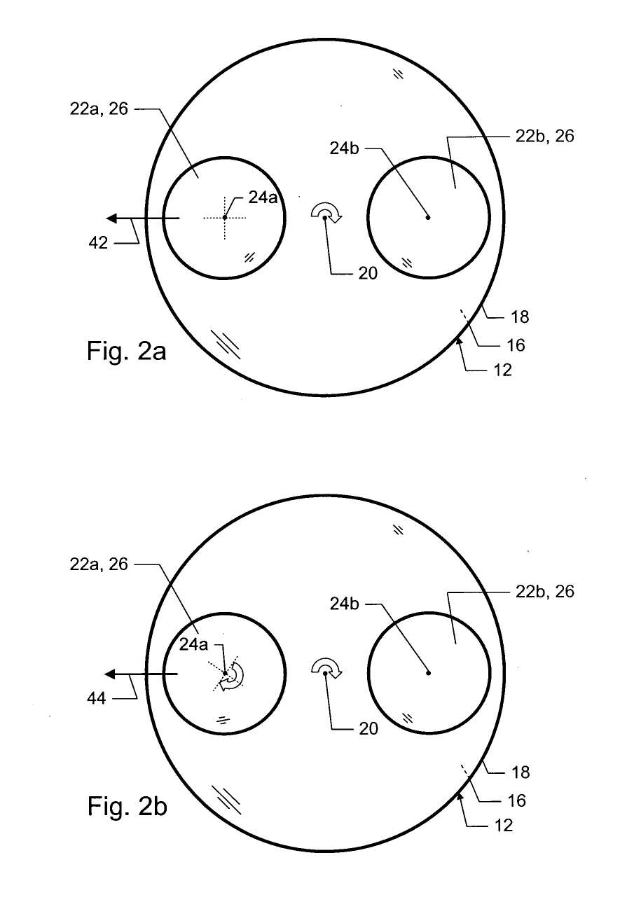

FIGS. 2a-2b are schematic top views of the apparatus of FIG. 1.

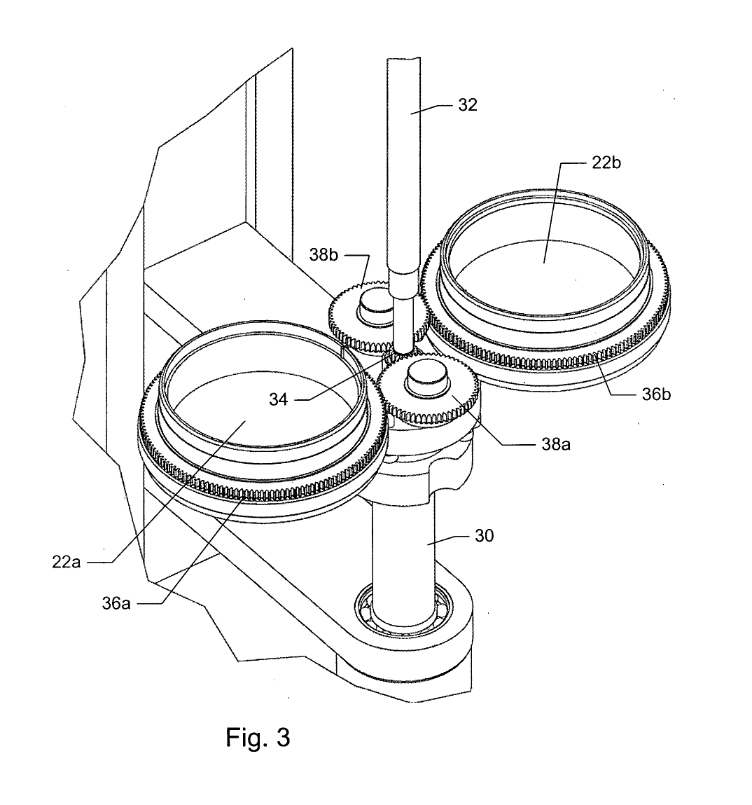

FIG. 3 is partial perspective view of the apparatus illustrated in FIGS. 1 and 2a-2b.

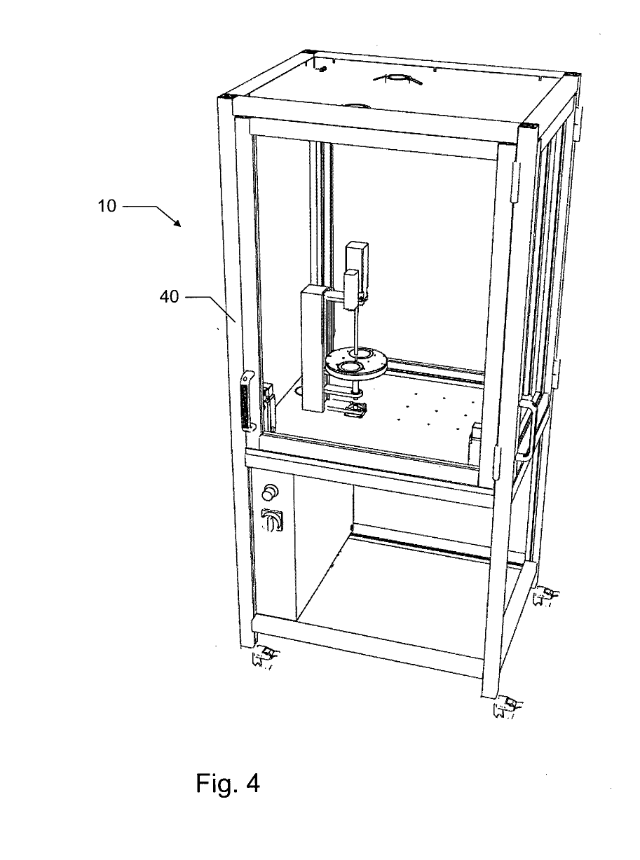

FIG. 4 is a perspective view of the present apparatus mounted in a safety cabinet.

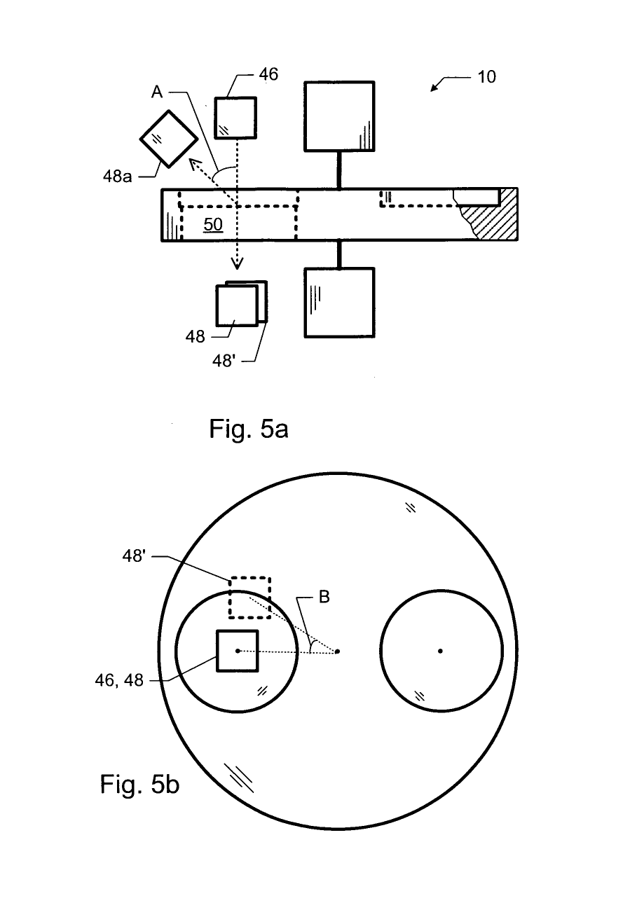

FIG. 5a is a side view of a centrifuge apparatus according another embodiment of the invention.

FIG. 5b is a top view of the apparatus of FIG. 5a.

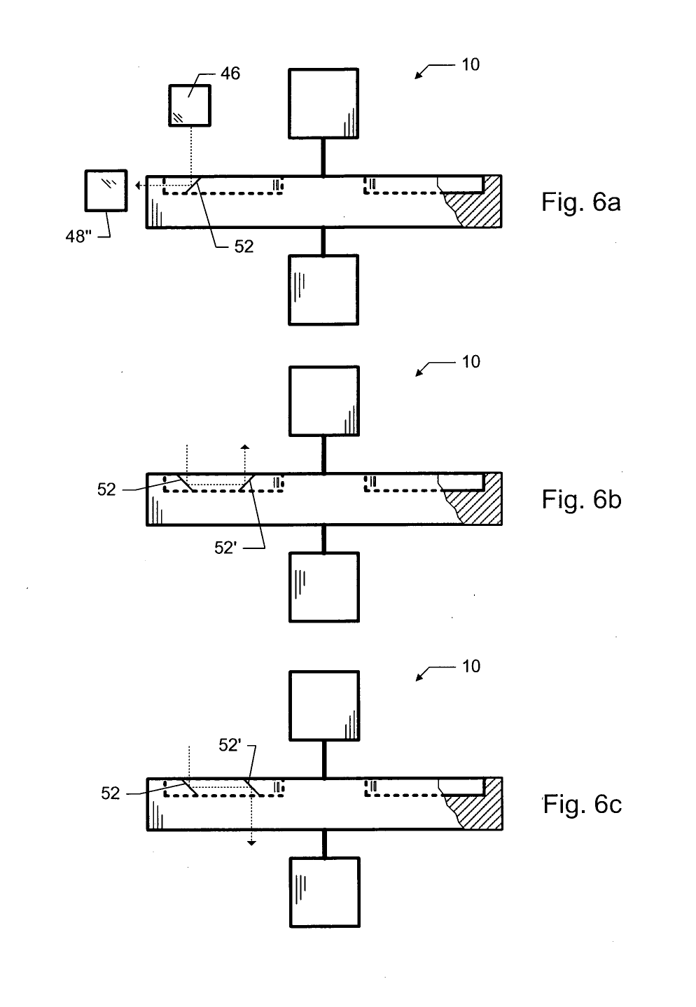

FIGS. 6a-6c are side views of a centrifuge apparatus according to further embodiments of the invention.

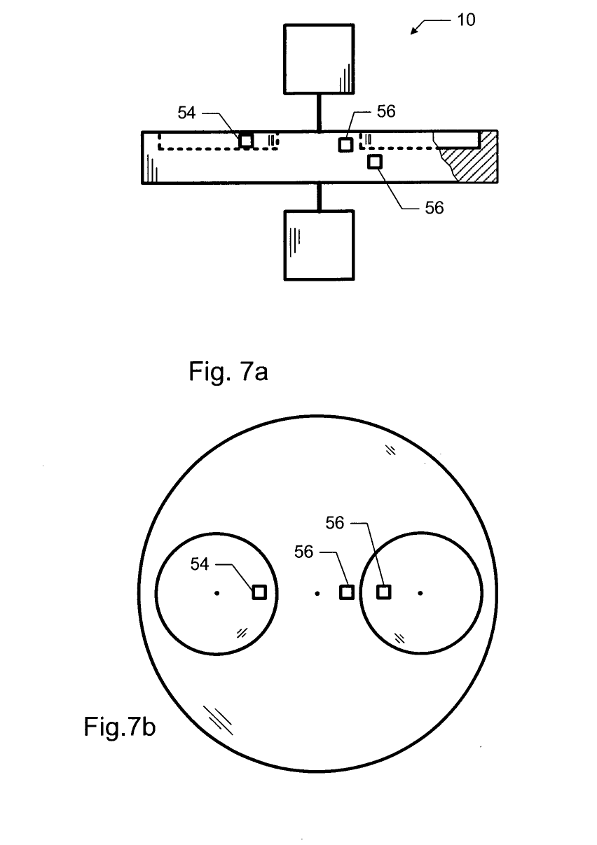

FIG. 7a is a side view of a centrifuge apparatus according yet another embodiment of the invention.

FIG. 7b is a top view of the apparatus of FIG. 7a.

A centrifuge apparatus according to the present invention in generally designated 10 throughout the figures. Also, the same or similar elements are designated with the same reference signs throughout the figures. Also, in some figures reference certain signs have been removed for clarity.

The apparatus 10 may be used for liquid processing and flow control within containers or cartridges as used for analytical, chemical processing or separating purposes. Controlled processing of fluidic elements in at least two dimensions may be performed.

Initially with reference to FIGS. 1 and 2a-2b, the apparatus 10 comprises a support member, namely a flat, circular disc or plate 12. The plate 12 is horizontally arranged. The plate 12 has an upper side 14, a lower side 16, and a rim 18. Further, the plate 12 is adapted to be rotated about a first axis 20. The first axis 20 is vertical, and it intersects through the centre of the plate 12.

The apparatus 10 further comprises two holding means 22a, 22b. The holding means 22a, 22b are arranged at the upper side 18 of the plate 12. The holding means 22a, 22b are symmetrically placed on opposite sides of the first axis 20, as viewed in FIG. 2. Each holding means 22a, 22b is adapted to rotate about a respective second axis 24a, 24b. Each holding 22 means may be rotated both clockwise and counter clockwise about its second axis 24, and these rotations are unlimited in both directions. The second axes 24a, 24b are vertical as the first axis 20. The first axis and the second axes are hence parallel. The second axis 24a intersects through the centre of the holding means 22a, and the other second axis 24b centrally intersects the holding means 22b. Each holding means 22a, 22b is further adapted to receive a sample processing device or cartridge 26, which in turn may contain one or more samples (not illustrated). The cartridge 26 may be secured in the holding means 22 for rotation thereof along with the holding means 22 about the second axis 24 (and also about the first axis 20 if the plate 12 is turned). The holding means may for instance be a rotating bay or compartment in which the sample processing cartridge may be placed and at least rotatably secured, or a rotatable peg on which the sample processing cartridge may be pegged, etc.

The sample processing cartridge 26 may be a fluidic or micro-fluidic sample processing cartridge. The cartridge may for instance include micro channels and a variety of fluidic cavities for handling, processing and transporting nL-quantities, μL-quantities and mL-quantities of various liquids. Further, the cartridge may be optically transparent or translucent. This allows studying of transportation of liquids, colour development, separations, etc. throughout the cartridge. The sample may be a fluidic sample, a liquid, a blood sample, etc. Also, the cartridge may contain one or more reagents. An exemplary sample processing cartridge that may be used in the apparatus 10 is disclosed in the applicant's co-pending patent application entitled “Sample processing cartridge and method of processing and/or analysing a sample under centrifugal force”, the content of which herein is incorporated by reference. However, other cartridges may be used as well, such as the sample processor card disclosed U.S. Pat. No. 4,883,763 (Holen et al.), the content of which herein is incorporated by reference.

It is envisaged that instead of being embodied as a plate, the support member may for instance have the shape of one or more arms for rotating the holding means about the first axis. Also, the support member need not be horizontally arranged, but can instead be vertically arranged, as the centrifugal force typically by far exceeds the gravitational force. The first and second axes would then be arranged horizontally. Also, instead of two holding means, the apparatus may include only one holding means, or more than two holding means. The apparatus may for instance include four holding means, which may be symmetrically distributed about the first axis 20. Also, the second axes 24 need not go through the center of the holding means, but may intersect anywhere within the holding means.

The apparatus 10 further comprises a first servo-mechanical motor 28a and a second servo-mechanical motor 28b. Generally, servo-mechanical motors (or servo motors) are representative of motors where exact rotational speed and rotational positioned may be defined and monitored at any time.

The servo-mechanical motors 28a, 28b are arranged off or remote from the plate 12, i.e. not on the plate 12, at opposite sides of the plate 12. The first motor 28a is positioned below the plate 12, while the second motor 28b is placed above the plate 12.

The first motor 28a is adapted to rotate the plate 12 about the first axis 20. To this end, the first motor 28a may be fixed or rigidly coupled to the plate 12 via a first drive shaft 30. The first drive shaft 30 may be a separate shaft or the output shaft of the first motor 28a. As illustrated, the first drive shaft 30 is co-axial with the first axis 20. The rotational ratio of the first motor 28a to the first drive shaft 30 is here 1:1, i.e. one turn of the motor corresponds to one turn of the shaft.

The second motor 28b is adapted to drive or rotate the two holding means 22a and 22b. The second motor 28b is mechanically connected or coupled to each of the holding means 22a, 22b, as illustrated in more detail in FIG. 3.

With reference to FIG. 3, the second motor 28b has a second drive shaft 32 co-axial with the first axis 22 (and aligned with the first drive shaft 30). The rotational ratio of the second motor 28b to the second drive shaft 32 is here 1:1.The second drive shaft 32 terminates at the plate 12 with a gear or gear wheel 34. The gear 34 is rigidly coupled to the second drive shaft 32, but not rigidly coupled to the plate 12. The gear 34 is further engaged with two intermediate gears 38a, 38b, one for each holding means. One intermediate gear 38a is further engaged with teeth 36a arranged on an outer circumference of one of the holding means 22a, and the other intermediate gear 38b is further engaged with teeth 36b on the outer circumference of the other holding means 22b. The diameter of the gear provided by the teeth 36a, 36b may have larger diameter than the gear 36 of the second drive shaft 32, to reduce the influence of any minor discrepancy in speed of the two motors. The gear ratio between the second motor 28b and the holding means 22 may for instance be 72:1, but any ratio is possible.

It is envisaged that the first and second motors may switch place, i.e. the lower motor controls the holding means, while the upper motor rotates the plate. No more motors than the first and second motors 28a, 28b are necessary to drive the plate 12 and the holding means 22a and 22b. Further, the intermediate gears 28a, 38b may be omitted.

Further, the apparatus 10 may comprise a safety frame or cabinet 40 in which the remaining components may be mounted, see FIG. 4. The servo-mechanical motors 28a, 28b are secured in the safety cabinet 40, and the plate 12 is then attached between the motors. The apparatus may further comprise suitable control means (not shown), to control the motors and allow the speed of the motors to be set, for instance by an operator.

An example of a mode of operation of the centrifuge apparatus 10 will now be described.

A sample processing cartridge 26 to which one or more samples to be processed or analysed has been supplied is placed and secured in one of the holding means 22a, 22b. Another sample processing cartridge may likewise be placed in the other holding means.

The two servo-mechanical motors 28a and 28b are then simultaneously initiated. The second motor 28b is running at exactly the same speed as the first motor 28a, with the first and second drive shafts 30 and 32 rotating in the same direction (clockwise or counter clockwise). The two motors 28a and 28b are capable of spinning the plate 12 at any speed, typically from 0.1 Hz to 80 Hz. Hence, at this setting, the sample is rotated about the first axis 20, but the holding means 22 are not rotated about their respective second axes 24, whereby the sample and cartridge are subjected to a centrifugal force 42. Thus, the cartridges 26 have fixed orientations relative to the direction of the centrifugal force.

Then, by changing the operational speed of one of the servo-mechanical motors 28a or 28b relative to the other, each holding means 22 and hence the sample(s) and any reagent(s) in the cartridge 26 is rotated also about its second axis 24, while still being rotated about the first axis 20. Hence, the orientations of the cartridges, with their channels and microfluidic cavities, are changed relative to the direction of the centrifugal force. This is synonymous with the fluidic reagents and sample being subjected to a centrifugal force 44 in another direction, relative to the cartridge 26 (FIG. 2b). Fluidic materials, like the at least one sample in the cartridge 26, that are exposed to centrifugal forces will at any time move to and stay within the available cavity in the cartridge 26 that is farthest away from the axis of the rotation generating the centrifugal force. Hence, changes in the orientation of the liquid containing cartridge 26 will allow full control of liquids movements within the cartridge.

That is, two-dimensional centrifugation may be obtained in the apparatus 10 by performing rotation of the individual cartridges 26 around one axis (second axis 24), while these cartridges 26 are exposed to a centrifugal force by being rotated by separate means (first motor 28a) around another distal axis (first axis 20).

The gear ratio between the second motor 28b and the holding means 22 determines how much each holding means 22 rotates about its own axis 24 in relation to the speed difference between the first motor 28a and the second motor 28b.

By then again setting the operational speed of the first and second motors 28a, 28b to the same value, the cartridges 26 are rotated about the first axis 20 only.

With reference to FIGS. 5a-5b, the centrifuge apparatus 10 may further comprise a light source 46. The light source 46 is directed towards the plate 12 for illuminating the sample processing cartridge 26 when the latter is placed in one of the holding means 22. The light source 46 may for instance be placed above the plate 12.

The light source 46 may for instance be a strobe light source adapted to emit strobe light, but it may alternatively be “regular” light source adapted to emit more continuant light. A strobe light source or a stroboscopic lamp, commonly called a strobe, is a device used to produce flashes of light. The duration of each such flash can be very short, typically a few hundred nanoseconds (e.g. 400 nanoseconds). The frequency of the flashes generated by the strobe can be linked (directly or indirectly) to the rotation of the rotating body. The flash may hence be controlled to appear periodically when an object (typically the cartridge 26) is at a defined position or angle. Typical rotational speeds are in the ranges from 0.1 to 80 Hz. At 80 Hz the object will only move an angle of approximately 0.01° during this flash. With typical radius of 30 mm to 50 mm of the plate 12, this do just represents a displacement of few gm during a flash. By this mean high resolution images can be made during the spinning of the cartridge 26.

Further, the apparatus 10 may comprise an optical sensor or digital camera 48 placed opposite the light source 46 for detecting light transmitted through the cartridge 26. The sensor or camera 48 is here placed below the plate 12. Any material, structure or surface that absorb and/or scatter light may be detected, imaged and/or measured. It is understood that the light source 46 and sensor or camera 48 may switch place with each other.

During operation, the light source 46 may illuminate the sample processing cartridge 26 and the sample and/or any reagent(s) therein, and the sensor or camera 48 may detect or photograph the resulting light transmitted through the cartridge 26. To this end, the plate 12 may be provided with a through opening or transparent portion 50 between its upper side 14 and lower side 16, which opening or transparent portion 50 is aligned with the light source 46 and sensor or camera 48 so as to allow light to pass from the light source 46 to the sensor or camera 48. The cartridge 26 being at least partly transparent or translucent will allow the light to pass also the cartridge 26. The camera 48 may be arranged to see (almost) the complete cartridge 26, in order to follow transportations of liquid throughout the complete cartridge 26. To this end, the width or diameter of the opening or transparent portion 50 may match that of the cartridge 26 as shown in FIG. 5a, and the holding means 22 may be ring-shaped with an inner ledge on which the cartridge 26 may rest.

Further, an optical sensor or camera 48a may also be placed on the same side of the plate 12 as the light source 46, to detect light reflected from the sample processing cartridge 26. In order to minimize specular reflection and still measure the diffuse reflection, a preferred organisation of the light source and the sensor both pointing at the same area of the cartridge with an interrelated angle A of typically 45 degrees.

The camera 48 can have various uses, including taking pictures or videos of the cartridges and their contents, in order to detect a cartridge ID (e.g. a bar code on the cartridge), the contents of the cartridge, errors, fluidic transportations within the cartridge, optical density, images for pixel analysis, colour analysis, etc.

As an alternative or complement to the sensor or camera 48 positioned vertically opposite the light source 46, the apparatus 10 may further comprise at least one optical sensor 48′ positioned at a different angular position about the first axis 20 compared to the light source 46, as seen from the top view. In a typical application, the light source 46 and the sensor 48′ may for instance be separated by 10 degrees (angle B), as illustrated in FIG. 5b. The sensor 48′ may for instance be a photodiode, a photomultiplier, avalanche diodes, multi photon pixel counters (MPCC) or similar, and the light source 46 may be the above mentioned strobe light source. This embodiment is in particular related to time resolved fluorescence where the light source 46 is used to excite the fluorophores (typically certain Lanthanide chelates) in the cartridge 26. By means of the strobe light source mentioned above, very exact onset of light excitation can be made during rotation. The emitted light from the fluorophores appears several hundreds of microseconds after the excitation by means of the light source 46. This implies that the light emitted from the illuminated object can be measured when this object has moved approximately 10° corresponding to a displacement of 9 mm, and the cartridge 26 may through rotation be moved from the position of excitation source (light source 46) to the position of the sensor 48′) for detecting the light emitted from the involved fluorophore. In this embodiment, the sensor 48′ is distinctly separated from and shielded from the light source 46. The rotational speed of the plate 12 may be adjusted to obtain optimal detection of the emitted light.

Further, with reference to FIGS. 6a-6c, the apparatus 10 may further comprise at least one reflective or reflecting element 52. The reflective element 52 generally provides for incoming light to be redirected in a longitudinal direction of the plate 12. In particular, the reflective element 52 may redirect light from the light source 46 (which light is incoming substantially perpendicularly to the plate 12) towards the rim 18 of the plate 12. The reflecting element 52 may for instance be a mirror or microoptical mirror element inclined about 45 degrees with respect of the surface of the upper (or lower) side 14 (16) of the plate 12. The reflecting element 52 may for instance be placed in the holding means 22 or in the cartridge 26.

During operation, the reflecting element 52 changes the direction of a light beam that comes from e.g. the light source 46 to pass radially in the plane of the cartridge 26. In this embodiment, the light beam may be sent through an elongated channel of light absorbing liquids and then be detected by an optical sensor 48″ placed along the rim 18 of the rotating plate 12. The increased light path will according to Beer Lambert Law increase the sensitivity and accuracy as compared to light going directly and vertically through the cartridge.

The reflective element 52 may be combined with an additional similar reflective element 52′ arranged so as to vertically redirect the lateral light out of the plate 12 or cartridge 26. The light may be coupled out on the same side of the plate as it was coupled in (FIG. 6b), or at the opposite side of the plate (FIG. 6c), depending on the orientation of the additional reflective element 52′.

With reference to FIGS. 7a-7b, the centrifuge apparatus 10 may further comprise various sensors and/or actuators provided to the plate 12 or to the holding means 22. The various other sensors/actuators may be magnetic, optical, thermal, etc.

The combination of several sensors/actuators, where measuring cells within the cartridge are brought in position for measurement by individual orientation and overall spinning of the cartridges, may extend the sensitivity range and improve overall performances.

The actuators/sensors may for instance be fixed to the holding means 22. An example of such an actuator/sensor is designated 54. Such actuators/sensors will at any time have the same positions relative to the cartridge 26. Typically, one or more heating and/or cooling elements (e.g. Peltier elements) may be fixed to the holding means 22 and positioned at defined positions relative to cavities within the cartridge 26. By this mean, the temperature of defined parts/cavities of the cartridge 26 may be controlled by the heating/cooling element. By rotating the cartridge 26 around its second axis 24, while spinning around the first axis 20, fluidic elements in the cartridge 26 can efficiently be moved between cavities of different temperatures. The fluidic elements can thereby be heated and/or cooled to defined temperatures. That is, fluidic elements within the cartridge can be transferred from one temperature zone to another. This can typically be utilized in performing temperature cycling as used in the Polymerase Chain Reaction (PCR) for the amplification of DNA.

The actuators/sensors fixed to the holding means 24 may also be magnetic or optical. As such elements are electrically controllable, they can be activated and deactivated by means know by persons skilled in the art.

The actuators/sensors may in other embodiments be fixed to the rotating plate 12. Examples of such actuators/sensors are designated 56. Typically, a magnet or a light diode may be placed fixed to the rotating plate 12. Cavities within the cartridge 26 can hence, by rotating the cartridge 26 around the second axis 24, be moved relative to the magnet. The strength of the magnetic field acting on magnetic materials within the cartridge 26 is thereby altered. One or several magnets (electromagnets or permanent magnets) may be placed at defined locations at the rotating plate 12 next to the sample processing cartridge 26. Rotation of the cartridge 26 around it second axis 24 will move the cavities or elements within the sample processing cartridge relative to the magnetic field. Any type of magnetic material within the cartridge may hence be exposed to both centrifugal and magnetic forces. These materials may be magnetic particles (both nanoparticles and microparticles), but may also be one or more magnetic elements in the millimetre sizes, such as a steel ball. The centrifugal force acting on these elements is controlled by the rotational speed around the first axis, while the effect of the magnetic field may be controlled by the rotation around the second axis. This second rotation will change the distance of the magnetic elements within the cartridge from the magnet field on the rotating plate (12). For instance, liquid containing magnetic particles may be quickly and efficiently transferred to areas where the magnetic field is strong and the magnetic particles will be addressed at this particular location, and then by further rotation of the cartridge 26, the particles may be removed from the strong magnetic field and are freed to be in a liquid suspension. The combined use of the magnetic field and the two dimensional centrifugation can hence be used for separation, mixing, moving magnetic objects relative to none magnetized objects, washing, etc.

The movements relative to the magnetic field may also be used to initiate on set or off set of electromagnetic actuators or sensors within the sample processing cartridge.

The rotational movement of the apparatus may also be utilized to harvest the electric power necessary to operate any actuators or sensors placed either directly on the rotating plate 12 or on the cartridge holding means 22.

An optical actuator provided to the plate or holding means of the apparatus 10 may include a laser for activating or releasing reagents in the cartridges 26, or an infrared source for heating purposes.

The person skilled in the art realized that the present invention by no means is limited to the embodiment(s) described above. On the contrary, many modifications and variations are possible within the scope of the appended claims.

For instance, instead of using servo motors, other motors may be used (e.g. electric motors) in combination with sensor systems which at any time measures the speed and position of both motors.

Also, instead of being arranged on opposite sides of the plate 12, the two motors may be placed on the same side of the plate, to free space on one side of the plate. In this embodiment, the drive shaft of one of the motors may extend inside the drive shaft of the other motor, wherein at least one of the motors is coupled to its drive shaft via for instance a gearing.

Further, the above described embodiments may be combined in various setups.

Further, the strobe light source, the optical sensor or camera 48′ placed at the different angular position, and/or the reflecting element(s) 52 may be used also in other applications than two-dimensional centrifugation, for instance one-dimensional centrifugation. Hence, it is envisaged a centrifuge apparatus which except for the rotatable support member also includes the strobe light source (but not necessarily the rotatable holding means and the second motor), a light source (e.g. the strobe light source) in combination with the optical sensor or camera placed at a different angular position about the plate's rotation axis, and/or the reflecting element(s) 52 and the optional camera placed at the rim of the support member.

1. A centrifuge apparatus (10), comprising:
a support member (12) rotatable about a first axis (20);
at least one holding means (22) mounted to said support member for rotation therewith about the first axis, wherein each holding means is adapted to rotate about a respective second axis (24) distal to said first axis and to receive a sample processing device (26) for rotation thereof also about the second axis;
a first motor (28a) adapted to rotate said support member about said first axis; and
a second motor (28b) coupled to said at least one holding means;
wherein the two motors (28a, 28b) are placed on opposite sides of the support member, and wherein the two motors (28a, 28b) are placed off the support member, the first motor is fixed to the support member via a first drive shaft (30) co-axial with the first axis, the second motor is coupled to the at least one holding means via a second drive shaft (32) co-axial with the first axis, and the apparatus is arranged such that the at least one holding means does not rotate about the respective second axis when the first and second drive shafts are rotated at the same speed but does rotate about the respective second axis when the first and second drive shafts are rotated at different speeds.

2. An apparatus according to claim 1, wherein the second drive shaft is provided with a gear (34) in direct or indirect engagement with teeth (36) on the holding means.

3. An apparatus according to any preceding claim, wherein the two motors are servo motors.

4. An apparatus according to any preceding claims, further comprising a light source (46) for at least partly illuminating a sample processing device received by the holding means.

5. An apparatus according to claim 4, wherein the light source is a strobe light source adapted to emit strobe light.

6. An apparatus according to claim 4 or 5, further comprising an optical sensor or camera (48′) placed at a different angular position about said first axis compared to said light source.

7. An apparatus according to any preceding claim, further comprising at least one reflecting element (52) arranged in the support member or holding means and adapted to redirect incoming light in a longitudinal direction of the support member, and vice versa.

8. An apparatus according to claim 7, further comprising an optical sensor or camera (48″) placed at the rim (18) of the support member.

9. An apparatus according to any preceding claim, further comprising at least one of:
at least one sensor (56) provided to the support member;
at least one sensor (54) provided to the at least one holding means;
at least one actuator provided to the support member; and
at least one actuator provided to the at least one holding means.

10. An apparatus according to claim 9, wherein the at least one sensor/actuator (54; 56) is magnetic, optical, or thermal.

11. An apparatus according to any preceding claim, wherein the sample processing device (26) is a micro-fluidic sample processing device.

12. Use of the apparatus (10) according to any preceding claim for centrifugation wherein the direction of a centrifugal force acting on the sample(s) in the sample processing device (26) is altered at will.

13. A centrifugation method, the method comprising:
supplying at least one sample and optionally one or more reagents in a micro-fluidic sample processing device;
placing the micro-fluidic sample processing device containing the at least one sample in the holding means of an apparatus (10) according to any one of the claims 1-11;
operating the two motors at the same speed for subjecting the sample to a centrifugal force acting in a first direction (42); and
changing the speed of one of the motors for subjecting the sample to a centrifugal force acting in a second direction (44).
